(19) United States
(12) Patent Application Publication
(10) Pub. No.: US 2018/0097456 A1
(43) Pub. Date: Apr. 5, 2018

(54) CIRCUIT AND METHOD FOR MULTIPHASE OPERATION OF AN ELECTRICAL MACHINE

(71) Applicant: HOCHSCHULE OSTWESTFALEN-LIPPE, LEMGO (DE)

(72) Inventors: JOHANN AUSTERMANN, BLOMBERG (DE); HOLGER BORCHERDING, HESSISCH-OLDENDORF (DE)

(21) Appl. No.: 15/563,771

(22) PCT Filed: Mar. 30, 2016
(86) PCT No.: PCT/DE2016/000137

§ 371 Date: Oct. 2, 2017

(30) Foreign Application Priority Data
Apr. 1, 2015 (DE) 10 2015 004 162.2

(51) Int. Cl. H02M 7/5387; H02M 7/53854

(52) U.S. Cl. CPC H02M 7/53871; H02M 2001/007; H02M 7/53854

(57) ABSTRACT

A circuit and a method operate an electrical machine connected to at least three phases of a power supply network through a frequency converter that has a DC link. By a synchronous inverter that is actuated by a DC chopper and has two bridge halves switching the positive and the negative half-waves respectively, the energy generated by the machine is fed back into the power supply network. Accordingly, the synchronous inverter has an asymmetrical configuration such that, to switch the potential tapped from the DC link by the DC chopper, switching is carried out by a first bridge half that is formed from thyristors as electronic switches, and such that the second bridge half contains reverse-blocking electronic switches able to be switched off.

The invention relates to a circuit and to a method for operating an electrical machine which is connected to at least three phases of a power supply network by means of a frequency converter comprising a DC intermediate circuit, in which circuit and method the energy generated by the machine is fed back into the power supply network by means of a synchronous inverter which is driven by a DC chopper controller and has two bridge halves which switch the positive and negative half-waves respectively.

Many electrical machines, such as asynchronous, synchronous or reluctance machines for example, are generally operated using frequency converters. The circuit of a frequency converter of this kind has a rectifier which feeds a DC intermediate circuit. A capacitor in this DC intermediate circuit serves for smoothing purposes, and an inductance which is frequently provided serves for interference-suppression purposes. The intermediate circuit further feeds an inverter, having controlled bridges for which metal-oxide-semiconductor field-effect transistors, MOSFETs, increase insulated gate bipolar transistors, IGBTs, or switching thyristors, integrated gate commutated thyristors, IGCTs, are frequently used.

The level of the output voltage and the frequency can advantageously be regulated within wide limits, so that, for example, electric motors can be controlled in an optimum manner.

Irrespective of whether two- or four-quadrant operation of the electrical machine is provided, energy is fed into the DC intermediate circuit when the machine is braked.

In simple drives, a so-called braking chopper is provided in the DC intermediate circuit, with which braking chopper the excess energy from the DC intermediate circuit is converted by a braking resistor into heat which is then emitted to the surrounding area. Therefore, braking resistors are generally arranged outside the frequency converter.

Apart from heating of the surrounding area in this way being less effective, the anticipation of braking resistors also requires extremely complicated structural measures since firstly the braking resistors can be very large, depending on the power of said braking resistors of course, and secondly sufficient cooling of the braking resistors has to be ensured. Therefore, it was frequently customary in the past to arrange braking resistors, for example, on the roof of electrical locomotives.

Against this background, complicated frequency converters and also matrix converters which are capable of feedback had been developed in the past, in particular in railway technology, said frequency converters and matrix converters being able to feed the generator braking power of the drive motors back into the single-phase railway power supply network.

The structural complexity and the associated costs, for example owing to the replacement of a diode rectifier with a converter having high-quality power transistors and a network filter of complex dimensions, may well prove worthwhile at high drive powers, but solutions of this kind are rarely used in comparatively small drive units since the use of the generator energy in a braking resistor is considerably more cost-effective than a solution involving feeding back energy.

WO 2013/020544 A1 discloses a method and a circuit for multiphase operation of an electric motor, which method and circuit allow feedback of generator energy in the event of braking even in small drives in an economical manner with low investment costs. In said document, the energy generated by the electrical machine is fed back into the power supply network by means of a synchronous inverter which switches a constant current i_{L}, which is provided by a DC chopper controller, clocked at a higher frequency, by means of an inductance, to the network phase with the highest voltage.

The rate of change in current di/dt is determined by the switchover rate of the synchronous inverter and is very high there. Since the network impedance of circuits of this kind is usually inductive, overvoltages which have to be limited by large network-side capacitors generally occur at very high rates of change in current di/dt.

Against this background, the object of the invention is to specify a cost-effective circuit and a simple method for feeding the energy supplied by an electrical machine in generator mode into a power supply network.

In the case of the circuit under discussion, this technical problem is solved as claimed in claim 1 by the measures that the synchronous inverter is of asymmetrical design in such a way that, for the purpose of switching the potential which is tapped off from the DC intermediate circuit by the DC chopper controller, switching is performed by a first bridge half comprising thyristors as electronic switches, and that the second bridge half has reverse-blocking electronic switches which can be switched off.

The circuit provides, like that according to WO 2013/020544 A1, a large number of advantages.

In particular, the customary circuit of a frequency converter with diode rectification can be retained and there is no interference in the forward path of the motor operation of the machine.

The use of thyristors, by nature reverse-blocking electronic switches, for the purpose of switching a half-wave of a network phase has, in conjunction with reverse-blocking electronic switches which can be switched off for the purpose of switching the other half-wave of the network phase, the advantage that it is possible to dispense with decoupling diodes which, in the circuit according to WO 2013/020544 A1, prevent charging of the smoothing capacitor in the DC intermediate circuit of the frequency converter when the feedback circuit is switched on.

In the case of the circuit according to WO 2013/020544 A1, it is further necessary to ensure that the switches of the synchronous inverter are switched over exactly at the zero crossing of the network phases. Otherwise, when IGBTs are used as electronic switches in the synchronous inverter, current may flow across the inverse diodes of the IGBTs, and this may lead to destruction of the components.

Currents of this kind are precluded owing to the use of reverse-blocking switches.

Furthermore, the use of thyristors is very cost-effective and driving of said thyristors is comparatively simple.

According to the invention, the electronic switches provided in the second bridge half are, in particular, IGBTs, preferably connected in series with a diode. This ensures that said switches are reverse-blocking switches which can be switched off.

When the decoupling or protective diodes are dispensed with, the DC chopper controller which drives the synchronous inverter can be directly connected to the DC intermediate circuit of the frequency converter.

A further advantage of the circuit according to the invention is the improved electromagnetic compatibility. The network impedance is usually inductive in the case of a feedback circuit under discussion. Therefore, overvoltages can occur when switching over the synchronous inverter bridges at a high rate of change in current di/dt. As in the circuit according to WO 2013/020544 A1, these overvoltages then have to be limited by large network-side capacitors.

However, owing to the circuit according to the invention, there is a very low rate of change in current di/dt when switching over the synchronous inverter bridges. As a result, filter capacitors of very low capacitance can be used for a network filter, it being possible for said filter capacitors to be advantageously connected between the load circuits of the electronic switches in each case.

The load circuits of the electronic switches can be directly connected to the power supply network in a simple manner in this case in particular.

A circuit of this kind is suitable, in particular, for any method for operating an electrical machine which is connected to at least three phases of a power supply network by means of a frequency converter, in which method the energy generated by the machine is fed back into the power supply network by means of a synchronous inverter which is driven by a DC chopper controller, in which method, as claimed in claim 7, the invention is based on the load current i_{L} being switched to the maximum and/or the minimum section of a network phase between the phase transitions of this network phase and the two closest network phases.

As a result of this measure, i_{L} is not fed back by means of a complete half-wave of a network phase, but rather i_{L} is always applied to the maximum or minimum section of a network phase over the phase angle.

Accordingly, the electronic switches have to be switched.

The thyristors of the first bridge half of the synchronous inverter can be switched on by means of their control connection, but cannot be switched off again. Switch off or turn off takes place when the current in the power path of the thyristors is at a zero crossing.

It is therefore provided that the DC chopper controller interrupts the connection to the DC intermediate circuit for turning off a thyristor, that a current gap where i_{L}=0 is switched in the current i_{L} in the electrical load circuit of the thyristors by the DC chopper controller, that the triggering current i_{z} of the thyristors is switched off with switching of the DC chopper controller, and that the IGBT which is associated with the thyristor switches off only after the thyristor is turned off.

When the DC chopper controller interrupts the current, which is to be fed back from the DC intermediate circuit, using an electronic switch, the current i_{L} will not immediately assume the value zero, on account of the inductance of the DC chopper controller, and therefore the thyristor remains switched on. The IGBT which is likewise switched on ensures, however, that the current flows away via the free-wheeling diode and therefore assumes the value zero and the thyristor is turned off with a time delay.

It may be expedient, for reasons of symmetry or owing to the use of special electronic switches, for a current gap i_{L}=0 to be switched for switching off each electronic switch.

Owing to all of the electronic switches of the synchronous inverter being switched off by means of the section of two network phases over the phase angle, thyristors which are intended to specifically switch a maximum or a minimum portion of a half-wave of a network phase are then also turned off. Said thyristors should then be triggered again, generally after passing through the maximum or minimum of a network phase of this kind.

For this reason, a current gap i_{L}=0 has to be switched over an extreme value of this kind of a network phase, the duration of said current gap being greater than the recovery time of the thyristors. The thyristor which is associated with this network phase can be triggered once again only after the recovery time has elapsed.

Between the gaps, the DC chopper controller regulates the current i_{L} at a value which is constant on average.

The invention will be explained in greater detail with reference to the drawing, in which only exemplary embodiments are illustrated. In the drawing:

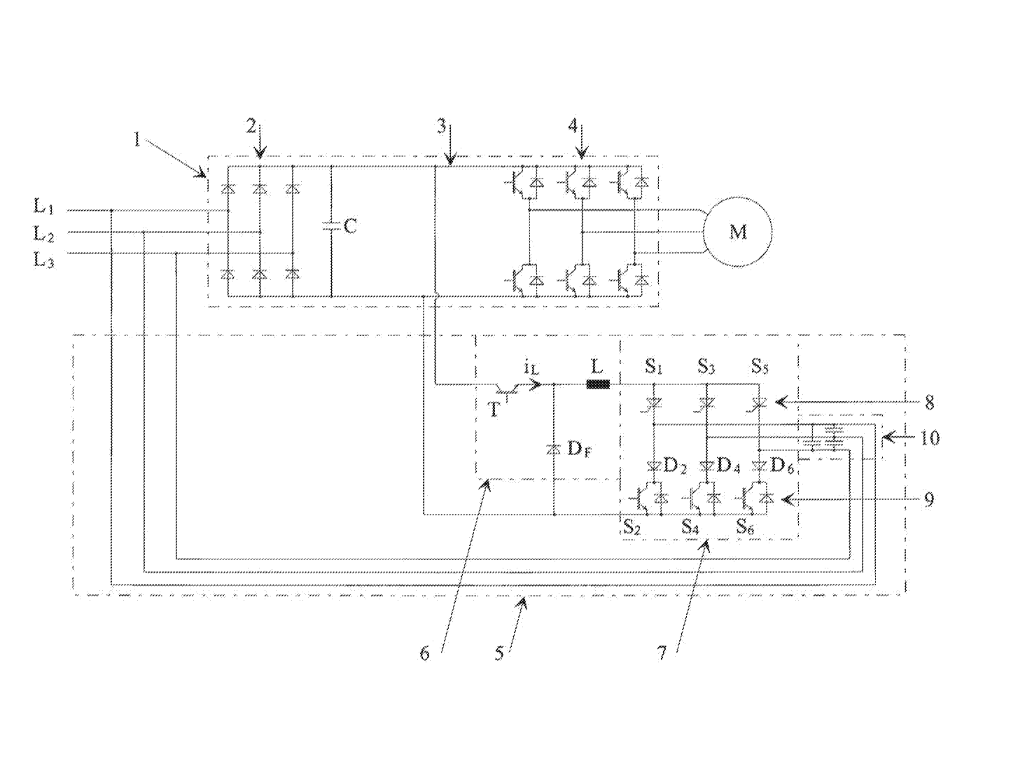

FIG. 1: shows an idealized circuit according to the invention

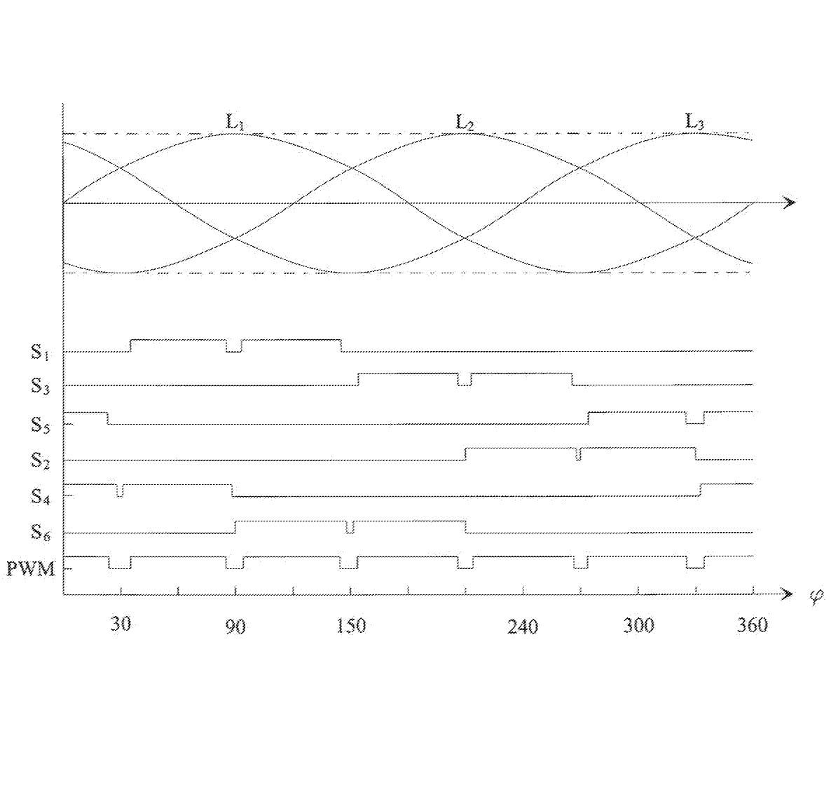

FIG. 2: shows the driving of the synchronous inverter is explained, and

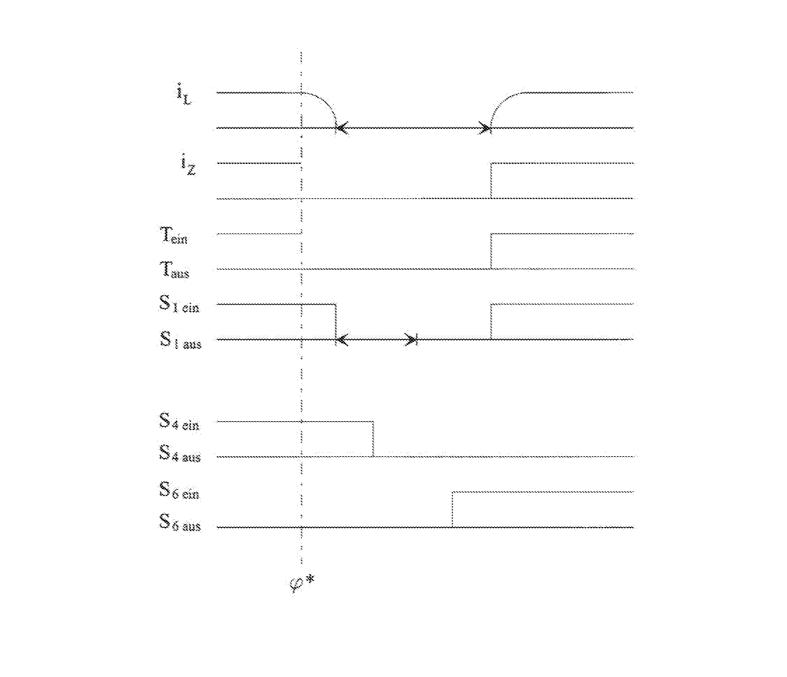

FIG. 3: shows reproduces an enlarged and supplemented detail from FIG. 2.

The circuit according to FIG. 1 shows an electrical machine M which is fed from a three-phase power supply network L₁, L₂, L₃ by means of a conventional frequency converter 1.

The frequency converter 1 has, in a customary manner, a diode rectifier 2 comprising a smoothing capacitor C, has a DC intermediate circuit 3 and has an inverter 4 which is fed from the DC intermediate circuit 3.

According to the invention, a feedback circuit 5 is connected to the DC intermediate circuit 3, in particular also as an independent assembly, which is formed separately from the frequency converter 1 and by which energy generated during generator operation of the machine M is fed back into the power supply network L₁, L₂, L₃.

The feedback circuit 5 has, at the input end, a DC chopper controller 6 which is directly connected, without protective or decoupling diodes, to the DC intermediate circuit 3 and feeds a synchronous inverter 7.

The DC chopper controller 6 has an electronic switch T, an inductance L and a free-wheeling diode D_{F} and switches the current i_{L} in the electrical load circuit of the synchronous inverter 7.

Since the DC chopper controller 6 taps off the positive potential of the DC intermediate circuit 3 in the exemplary embodiment, the synchronous inverter 7 has, as reverse-blocking switches, thyristors S₁, S₃, S₅ in the upper, first bridge half 8, while the reverse-blocking electronic switches S₂, S₄, S₆ of the second bridge half 9 which can be switched off are formed by IGBTs which are connected in series with diodes D₂, D₄, D₆.

If, as an alternative, the DC chopper controller taps off the negative potential of the DC intermediate circuit, a mirror-image circuit topology is produced.

In the exemplary embodiment, the outputs of the switches S₁-S₆ are further directly connected to the network phases L₁-L₃. In the case of the network filter 10 which is provided in any case, inductances are entirely dispensed with and capacitors of high capacitance are dispensed with. The network filter 10 has only three capacitors, which are connected between the outputs of the switches S₁-S₆.

The behavior of the circuit according to FIG. 1 will be explained further with reference to FIGS. 2 and 3.

FIG. 2 shows, in a top graph, the phase profile of the voltage of the three network phases L₁, L₂, L₃ with respect to the network angle cp. The, here, three network phases L₁, L₂, L₃ are respectively phase-shifted through 120°.

In the bottom graph of FIG. 2, the switching behavior of the electronic switches S₁-S₆ with respect to the network angle φ is illustrated in an idealized manner. The release of the pulse width modulation of the DC chopper controller 6, PWM, is plotted beneath the switching behavior curves, the turn-off condition i_{L}=0 occurring at the off times of said pulse width modulation for the purpose of switching off the thyristors.

FIG. 2 demonstrates, overall, that the switches S₁-S₆ switches the energy which is to be fed back substantially only to the maximum or minimum sections of a network phase between the intersection points with the two other phases. For example, S₁ is on approximately between the phase angles φ=30° and φ=150°. When the switch S₁ is blocked, S₃ is on up to approximately φ=270° etc. The same applies for the low side.

For the purpose of turning off a thyristor S₁, S₃, S₅, it is necessary, in addition to switching off the triggering current i_{z}, for the current i_{L} to be zero. In order to ensure this, the electronic switch T of the DC chopper controller 6 interrupts the connection to the DC intermediate circuit 3. However, this does not immediately result in i_{L}=0. Instead, the IGBTs S₂, S₄, S₆ have to remain switched on for a somewhat longer period than the corresponding thyristors S₁, S₃, S₅, so that i_{L} of the inductance L can be reduced via the free-wheeling diode D_{F}. The corresponding thyristor S₁, S₃, S₅ is turned off only when i_{L}=0.

According to the illustration in FIG. 2, a current gap i_{L}=0 of this kind necessarily has to be switched at a phase angle of approximately φ=30° for the phase transition from L₃ to L₁, at a phase angle of approximately φ=150° for the phase transition from L₁ to L₂, and at a phase angle of approximately φ=270° for the phase transition from L₂ to L₃.

FIG. 2 further shows that, in the exemplary embodiment, these current gaps i_{L}=0 is also provided when switching off the IGBTs S₂, S₄ and S₆, for reasons of symmetry for example. However, in particular, the EMC behavior is improved by this measure since i_{L} is again reduced via the free-wheeling diode D_{F}. Therefore, the thyristors which are on are also turned off in the region of the maximum of the corresponding network phase. This results in small rates of change in current di/dt.

This switching behavior is explained by way of example with reference to FIG. 3. According to FIG. 3, the current i_{L} is regulated at a constant value by the DC chopper controller 6 before reaching a phase angle φ*<90°. The switches S₁ and S₄ which are on switch the current i_{L} to the phases L₁ and L₂.

At φ*, the switch T of the DC chopper controller 6 is opened and the triggering current i_{z} for the thyristors S₁, S₃, S₅ is switched off. Nevertheless, the thyristor S₁ remains switched on since the current i_{L} is not yet zero. The IGBT S₄ remains switched on beyond φ* and the current i_{L} can be reduced via the free-wheeling diode D_{F}. Once i_{L}=0 is reached, the thyristor S₁ is switched off.

In this case, the rate of change in current di/dt is prespecified by the inductance L and the network voltage and is advantageously set at a low value.

The recovery time of the thyristor S₁ begins at i_{L}=0 in accordance with the double-headed arrow there. The IGBT S₄ remains switched on even beyond said time. S₄ is also switched off only when it is ensured that i_{L}=0 and the thyristor S₁ is turned off. The IGBT S₆ further switches on within the current gap i_{L}=0, in accordance with the top double-headed arrow in FIG. 3.

After the recovery time of the thyristor S₁ has elapsed, T and therefore i_{z} and i_{L} can be switched on again. Accordingly, the thyristor S₁ is also triggered again.

1-11. (canceled)

12. A circuit for operating an electrical machine, the circuit comprising:
a frequency converter for connecting to at least three phases of a power supply network, said frequency converter having a DC intermediate circuit;
a direct current (DC) chopper controller; and
a synchronous inverter, energy generated by the electrical machine being fed back into the power supply network by means of said synchronous inverter being driven by said DC chopper controller, said synchronous inverter having two bridge halves for switching positive and negative half-waves respectively, said synchronous inverter being of an asymmetrical configuration such that, for switching a potential being tapped off from said DC intermediate circuit by said DC chopper controller, switching is performed by a first bridge half having thyristors as electronic switches, and a second bridge half having reverse-blocking electronic switches which can be switched off.

13. The circuit according to claim 12, wherein said reverse-blocking electronic switches of said second bridge half are insulated-gate bipolar transistors (IGBTs).

14. The circuit according to claim 13, wherein said second bridge half has a plurality of series circuits each containing one of said IGBTs and a diode.

15. The circuit according to claim 12, wherein said DC chopper controller driving said synchronous inverter is directly connected to said DC intermediate circuit of said frequency converter.

16. The circuit according to claim 12, further comprising in each case one capacitor functioning as a network filter and connected between load circuits of said reverse-blocking electronic switches.

17. The circuit according to claim 12, wherein said reverse-blocking electronic switches having load circuits directly connected to the power supply network.

18. A method for operating an electrical machine being connected to at least three phases of a power supply network via a frequency converter having a direct current (DC) intermediate circuit, which comprises the steps of:
feeding back energy generated by the machine into the power supply network by means of a synchronous inverter being driven by a DC chopper controller; and
switching a load current i_{L} to a maximum and/or a minimum section of a network phase between phase transitions of the network phase and two closest network phases.

19. The method according to claim 18, which further comprises:
interrupting, via the DC chopper controller, a connection to the DC intermediate circuit for turning off a thyristor of the synchronous inverter; and
switching in a current gap where i_{L}=0 in the load current i_{L} in an electrical load circuit of thyristors of the synchronous inverter by the DC chopper controller, a triggering current i_{z} of the thyristors is switched off with a switching of the DC chopper controller, and an insulated-gate bipolar transistor (IGBT) which is associated with the thyristor switches off only after the thyristor is turned off.

20. The method according to claim 19, wherein the current gap i_{L}=0 is switched for switching off each electronic switch.

21. The method according to claim 20, wherein the current gap i_{L}=0 is switched over the maximum of the network phase, a duration of the current gap being greater than a recovery time of the thyristors, and in that a thyristor which is associated with the network phase is triggered once again.

22. The method according to claim 19, wherein between gaps, the DC chopper controller regulates the load current i_{L} at a value which is constant on average.
